(19) United States
(12) Patent Application Publication
(10) Pub. No.: US 2004/0150993 A1
(43) Pub. Date: Aug. 5, 2004

(54) Illuminated sound and image display for an infant

(76) Inventors: Craig McElhaney, Cumberland, RI (US); Robert Fisher, North Kingstown, RI (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/355,893

(22) Filed: Jan. 31, 2003

(51) Int. Cl. F21V 21/14

(52) U.S. Cl. 362/250; 362/251; 362/806

(57) ABSTRACT

The present invention is directed to an illuminated display for use by an infant that may include a cylinder fabricated from a translucent material that may have at least one image disposed on a surface of the cylinder, a motor operatively coupled to the cylinder that may be adapted to rotate the cylinder when the motor is activated, and an illumination source disposed within the cylinder that may be adapted to project light outwardly through the surface of the cylinder. The illuminated display may further include a dome in which the cylinder and the illumination source may be disposed and that may be adapted so that the light projecting from the illumination source through the surface of the cylinder may project at least one projected image on the dome corresponding to the at least one image disposed on the surface of the cylinder, with the at least one projected image being visible from the exterior of the dome. The cylinder, the illumination source and the dome may further be adapted such that the at least one projected image has a first size when the cylinder rotates through a first position and a second size when the cylinder rotates through a second position.

### BACKGROUND

The patent is directed to an infant toy, and more particularly to an illuminated sound and image display wherein moving images are projected onto the surface of a dome while accompanying music is played over a speaker.

Various infant toys wherein illuminated images are projected and music is played have been previously described. For example, U.S. Pat. Nos. 4,942,502 and 4,858,079 to Ohashi disclose a light-projecting toy musical box projecting a light pattern which is synchronized with musical sound generated by an acoustic mechanism. The projected light patterns are formed by providing a lamp within a base and rotatably mounting a dome over the lamp and substantially on top of the base. The dome is made out of translucent material which is patterned with a semi-opaque coating so as to form light patterns on the dome itself and project the light patterns on adjacent ceilings and/or walls of a room.

U.S. Pat. No. 5,310,377 to Joja discloses an illuminated sound-producing toy comprising a base frame, a drive mechanism, a sound-producing mechanism, an opening formed in the base frame, a mirror fitted in the opening, an electric lamp, a switch and a first light-transmitting board. The sound-producing mechanism is capable of being driven by the drive mechanism, and the switch turns the electric lamp on and off. The first light-transmitting board is positioned generally between the mirror and the electric lamp, and is driven through a predetermined motion by the drive mechanism. The first light-transmitting board comprises an illustration display area so that illustrations can be seen through the mirror means only when the electric lamp is on.

In addition, U.S. Pat. No. 5,685,097 to Marinov discloses an illuminated colored display device includes a base, and at least two translucent members which are supported on turntables which are in turn supported by the base and are rotated with respect to the base by a drive system included in the base. The translucent members, which in the preferred embodiment are of a frustum shape, surround a source of illumination which is also supported on the base. Colored patterns consisting of areas of two or more colors or clear areas are provided on the translucent members. A third translucent member, which is supported on the base on a fixed position, is of the same general shape as the others, but is formed with regions of varying thickness such that it distorts the light passing through it so as to both magnify and reduce the various colored areas to provide a visual effect which varies in color and shape. An opaque cover is supported on the third translucent member over the ends of all the translucent members. The translucent members may be lifted from the base to gain access to the source of illumination which in the preferred embodiment is an electric light bulb.

### SUMMARY OF THE INVENTION

In one aspect, the invention is directed to an illuminated display for use by an infant that may include a cylinder fabricated from a translucent material that may have at least one image disposed on a surface of the cylinder, a motor operatively coupled to the cylinder that may be adapted to rotate the cylinder when the motor is activated, and an illumination source disposed within the cylinder that may be adapted to project light outwardly through the surface of the cylinder. The illuminated display may further include a dome in which the cylinder and the illumination source may be disposed and that may be adapted so that the light projecting from the illumination source through the surface of the cylinder may project at least one projected image on the dome corresponding to the at least one image disposed on the surface of the cylinder, with the at least one projected image being visible from the exterior of the dome. The cylinder, the illumination source and the dome may further be adapted such that the at least one projected image has a first size when the cylinder rotates through a first position and a second size when the cylinder rotates through a second position.

In another aspect, the invention is directed to an illuminated display for use by an infant may include a lamp having a dome fabricated from a translucent material, and having an oblong cross-section and a coated surface, and a rotatable cylinder fabricated from a translucent material that may be disposed within the dome. The cylinder may have a circular cross-section and at least one image disposed on a surface of the cylinder. The lamp may further include a first illumination source disposed within the cylinder that may be adapted to project light outwardly through the surface of the cylinder such that the light projecting from the first illumination source through the surface of the cylinder may project at least one projected image on the coated surface of the dome corresponding to the at least one image disposed on the surface of the cylinder. The at least one projected image may have a first size when the cylinder rotates through a first position, and a second size when the cylinder rotates through a second position. Still further, the lamp may include a second illumination source disposed within the dome, a motor operatively coupled to the cylinder that may be adapted to rotate the cylinder when the motor is actuated, a first switch, a second switch, a speaker that may be adapted to output sounds, and a controller coupled to the first illumination source, the second illumination source, the motor, the first switch, the second switch and the speaker.

The controller may be programmed to detect a first actuation of the first switch, to activate the first illumination source and the motor in response to detecting the first actuation of the first switch, and to cause the speaker to output a first musical sound. The controller may also be programmed to operate in a first mode wherein the controller may be programmed to detect a second actuation of the first switch and cause the speaker to output a second musical sound in response to detecting the second actuation of the first switch, and to cease causing the speaker to output sound at the conclusion of the first musical sound. Still further, the controller may be programmed to operate in a second mode and to detect a second actuation of the first switch, to cause the speaker to output a plurality of musical sounds for a predetermined period of time during which the controller does not detect the second actuation of the first switch, and to cease causing the speaker to output the plurality of musical sounds in response to detecting the second actuation of the first switch, and to detect an actuation of the second switch and to activate the second illumination source in response to detecting the actuation of the second switch.

The illuminated display may further include a base having a housing, a first activation member mounted on the housing, a second activation member mounted on the housing, and a receptacle in the housing that may be adapted to demountably receive the lamp. The first switch may be aligned with the first activation member when the lamp is disposed within the receptacle such that movement of the first activation member from a first switch disengaged position to a first switch engaged position causes actuation of the first switch. The second switch may be aligned with the second activation member when the lamp is disposed within the receptacle such that movement of the second activation member from a second switch disengaged position to a second switch engaged position causes actuation of the second switch.

In a further aspect, the invention is directed to an illuminated display for use by an infant that may include a dome that may have a first cross-section, a rotatable cylinder fabricated from a translucent material and disposed within the dome, and that may have a second cross-section and at least one image disposed on a surface of the cylinder. The illuminated display may further include a first illumination source disposed within the cylinder that may be adapted to project light outwardly through the surface of the cylinder such that the light projecting from the first illumination source through the surface of the cylinder may project at least one projected image on the dome corresponding to the at least one image disposed on the surface of the cylinder, with the at least one projected image being visible from the exterior of the dome. The first and second cross-sections may be configured such that the at least one projected image may have a first size when the cylinder rotates through a first position and a second size when the cylinder rotates through a second position.

The illuminated display may further include a motor operatively coupled to the cylinder that may be adapted to rotate the cylinder when the motor is actuated, a first switch, a speaker that may be adapted to output sounds, and a controller coupled to the first illumination source, the motor, the first switch, and the speaker. The controller may be programmed to detect a first actuation of the first switch, to activate the first illumination source and the motor in response to detecting the first actuation of the first switch, and to cause the speaker to output a first musical sound. The controller may also be programmed to operate in a first mode wherein the controller is programmed to detect a second actuation of the first switch and cause the speaker to output a second musical sound in response to detecting the second actuation of the first switch, and to cease causing the speaker to output sound at the conclusion of the first musical sound.

Additional aspects of the invention are defined by the claims of this patent.

### BRIEF DESCRIPTION OF THE DRAWINGS

FIG. 1 is a front perspective view of an embodiment of an illuminated sound and image display for an infant;

FIG. 2 is a front perspective view of the illuminated sound and image display of FIG. 1 with the lamp separated from the base;

FIG. 3 is a front bottom perspective view of the illuminated sound and image display of FIG. 1 with the activation bar separated from the base;

FIG. 4a is a side cross-sectional view through line 4-4 of the activation bar of the illuminated sound and image display of FIG. 1 in the normal position;

FIG. 4b is a side cross-sectional view through line 4-4 of the activation bar of the illuminated sound and image display of FIG. 1 in the activated position;

FIG. 5 is a bottom perspective view of one of the activation buttons and linkages of the illuminated sound and image display of FIG. 1;

FIG. 6a is a side cross-sectional view through line 6-6 of the activation button and linkage of FIG. 5 in the normal position;

FIG. 6b is a side cross-sectional view through line 6-6 of the activation button and linkage of FIG. 1 in the activated position;

FIG. 7 is a front elevational view of the lamp of the illuminated sound and image display of FIG. 1;

FIG. 8 is a bottom view of the lamp of the illuminated sound and image display of FIG. 1 with the battery compartment cover removed;

FIG. 9 is a front perspective view of the illuminated sound and image display of FIG. 1 with the lamp separated from the base and the dome removed from the lamp;

FIG. 10 is front perspective view of the lamp of the illuminated sound and image display of FIG. 1 with the dome removed and the cover plate separated from the lamp; and

FIG. 11 is a block diagram of the electronic components of the illuminated sound and image display of FIG. 1.

### DETAILED DESCRIPTION OF VARIOUS EMBODIMENTS

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

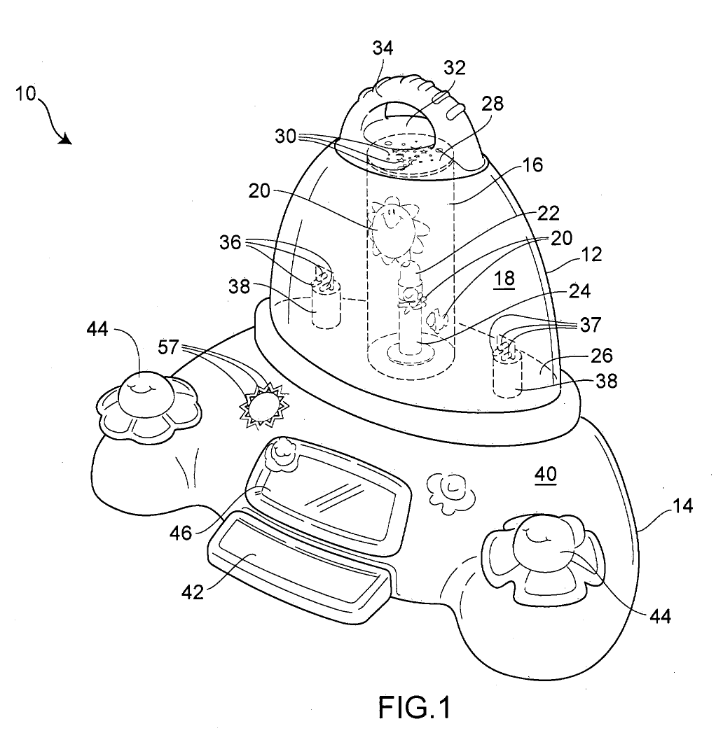

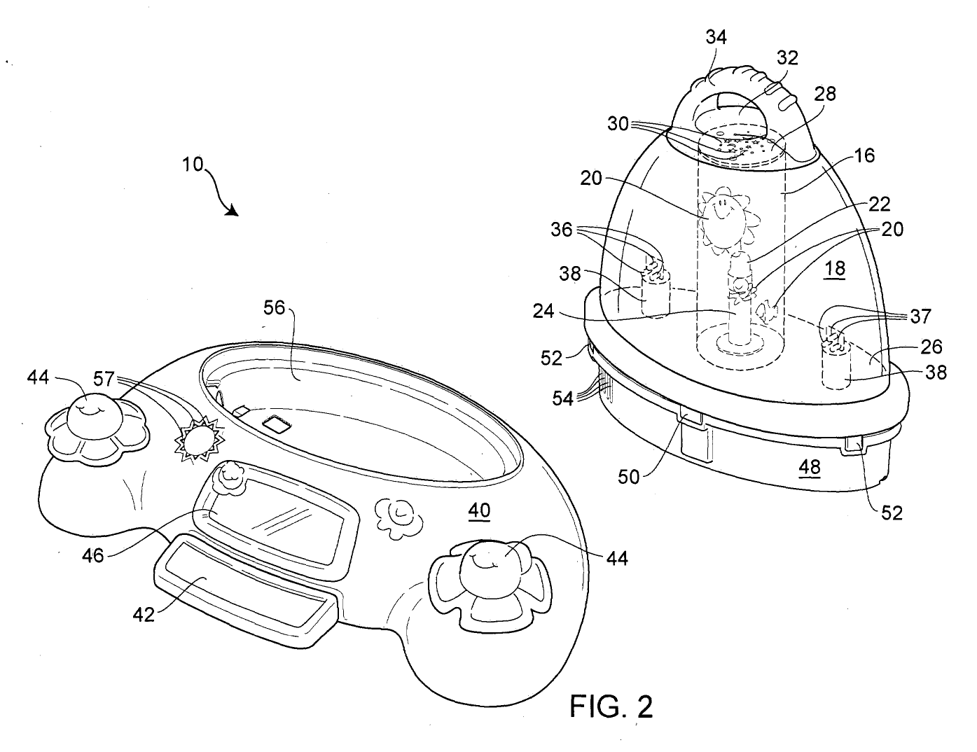

FIGS. 1 and 2 illustrate one possible embodiment of an illuminated sound and image display 10 for use by an infant that may include a lamp 12 that is removable from a base 14. In the illustrated embodiment, the illuminated display 10 may be configured to project moving images and music that encourage an infant to interact with the illuminated display 10 when the lamp 12 is inserted into the base 14 as illustrated in FIG. 1. The illuminated display 10 may also be configured to function as a nightlight when the lamp 12 is removed from the base 14, as shown in FIG. 2, and placed adjacent to the infant's crib.

Referring to FIG. 1, the lamp 12 of the illuminated display 10 may include a rotatable translucent cylinder 16 disposed within a translucent dome 18. The cylinder 16 may be wholly or partially coated with an opaque or semi-translucent material in the form of indicia 20 creating images on the surface of the cylinder 16. The images formed by the indicia 20 may be in the form of animals, characters, or other real or imaginary objects. The inner surface of the dome 18 may include a semi-translucent coating on which the images formed by the indicia 20 of the cylinder 16 may be projected by an illumination source, such as a light 22, disposed within the cylinder 16. Alternatively, the dome 18 may be fabricated from a semi-translucent material such that images may be projected onto the dome 18 and viewable from the exterior of the lamp 12 without the need for an additional coating on a surface of the dome 18. As a further alternative, the dome 18 or a surface thereof may be textured or otherwise configured so that images may be projected thereon. The light 22 may be disposed on a support post 24 to raise the light 22 above the surface of a cover plate 26 of the lamp 12.

When illuminated, the light 22 projects the images formed by the indicia 20 onto the dome 18 such that the images are visible from the exterior of the dome 18. The dome 18 may be shaped so that the projected images may change size or be otherwise distorted as the cylinder 16 rotates within the dome 18. For example, the dome 18 may have an oval or oblong horizontal cross-section wherein the distance between the outer surface of the cylinder 16 and the inner surface of the dome 18 varies between a maximum distance at the ends of the lamp 12, and a minimum distance proximate the center of the lamp 12. As the cylinder 16 rotates, the size of an image created by particular indicia 20 on the cylinder 16 on the dome 18 will vary between a minimum size when the image is projected on the portions of the dome 18 having the smallest diameter and a larger size at the portion of the dome 18 having the largest diameter.

While the dome 18 is illustrated herein as having an oval or oblong horizontal cross-section decreasing in size as the dome 18 progresses upwardly from a cover plate 26, those skilled in the art will understand that the dome 18 may be configured with other cross-sectional geometries that may cause projected images to change in size or be otherwise distorted as the cylinder 16 rotates and the images are projected onto different portions of the dome 18. For example, the dome 18 may maintain a substantially uniform oval cross-section as the dome 18 extends upwardly from the cover plate 26. Alternately, the dome 18 may have a constant or varying cross-section that is triangular, square, quadrilateral, polylateral, or any other uniform or non-uniform cross-section that may cause the images to distort as the cylinder 16 rotates.

As a further alternative, the projected images may be caused to change size and/or shape by positioning cylinder 16, the dome 18 and/or the light 22 asymmetrically with respect to each other. For example, the cylinder 16 and the dome 18 may be configured with circular cross-sections, and with the longitudinal axis of the cylinder 16 being offset or non-coincident with the longitudinal axis of the dome 18. Configured in this way, the distance between the image on the surface of the cylinder 16 and the projected image on the surface of the dome 18 changes as the cylinder 16 rotates, thereby causing the size of the projected image to increase and decrease in proportion to the distance between the image and the projected image. Similarly, the light 22 may be offset from the longitudinal axis of the cylinder 16 such that the projected images change size as the cylinder 16 rotates about the light 22. Other configurations of the cylinder 16, the dome 18 and the light 22 wherein the size and shape of the projected images changes as the cylinder 16 rotates will be apparent to those skilled in the art as having use with an illuminated display in accordance with the invention.

The cylinder 16 may further include a cap 28 attached to the end of the cylinder 16 opposite the cover plate 26. The cap 28 may include a plurality of apertures 30 therethrough, which may be in the shape of stars, moons, other heavenly bodies, or any other images for which is desired to project upwardly on a top portion 32 of the dome 18. The illumination of the light 22 may pass through the apertures 30 of the cap 28 and project onto the inner surface of the dome 18 at the top portion 32. A handle 34 may be connected proximate the top portion 32 of the dome 18 and be configured to provide an opening so that the images projected onto the top portion 32 of the dome 18 are visible from the outside of the dome 18.

The lamp 12 may further include additional light sources, such as light omitting diodes (LEDs) 36 and 37 disposed within the dome 18. The LEDs 36 and 37 may be mounted atop support posts 38 to raise the LEDs 36 and 37 above the cover plate 26. The LEDs 36 and 37 may be operated independently of the light 22, and may be visible from the exterior of the dome 18 when the LEDs 36 and 37 are illuminated. Of course, those skilled in the art will understand as few as one additional light source, or any number and arrangement of a plurality of additional light sources may be implemented in an illuminated display in accordance with the invention.

The base 14 may include a housing 40 adapted to receive the lamp 12 and facilitate activation of the light 22 and LEDs 36 and 37 in a manner described more fully below. The base 14 may further include an activation bar 42 and activation buttons 44 mounted thereon and attached to mechanical linkages (not shown) to activate the lamp 12 in a manner described more fully below. Additionally, a mirror 46 may be mounted on the housing 40 of the base 14, which may provide further simulation and/or interaction for the infant.

Referring now to FIG. 2, the illuminated display 10 is illustrated with the lamp 12 separated from the base 14. The lamp 12 may include a lamp housing 48 in which various internal components of the lamp 12 may be disposed, and which may support a main control switch 50 and auxiliary switches 52 that may control the activation of the light 22 and LEDs 36 and 37, and other functions of the lamp 12. While the switches 50 and 52 are is illustrated herein as being mechanical switches, it is contemplated that other types of switches which may be capable of being actuated directly by a user of the illuminated display 10, or by interaction with other actuation mechanisms such as those described herein, may be useful with an illuminated display 10 in accordance with the invention. For example, photosensitive switches in the form of optical sensors may be implemented to detect differences in the amount of light proximate the switches when the actuation mechanisms are manipulated. Other types of switches, such as pressure sensors and displacement sensors, having use with the illuminated display 10 in accordance with the invention will be apparent to those of ordinary skill in the art.

The lamp housing 48 may also include a plurality of speaker openings 54 through which sounds may be broadcast by a speaker (not shown) disposed within the lamp housing 48. The lamp housing 48 may be configured to be inserted into a receptacle 56 in the housing 40 of the base 14 when disposed within the receptacle 56, the lamp housing 48 may be aligned with the linkage mechanisms of the base 14 so that manipulation of the activation bar 42 may actuate the main control switch 48, and manipulation of one of the activation buttons 44 may actuate the corresponding auxiliary switch 52. Moreover, the housing 40 may further include a plurality of openings 57 therethrough disposed proximate the speaker opening 54 when the lamp 12 is disposed in the base 14 to allow the sound broadcast by the lamp 12 to be audible.

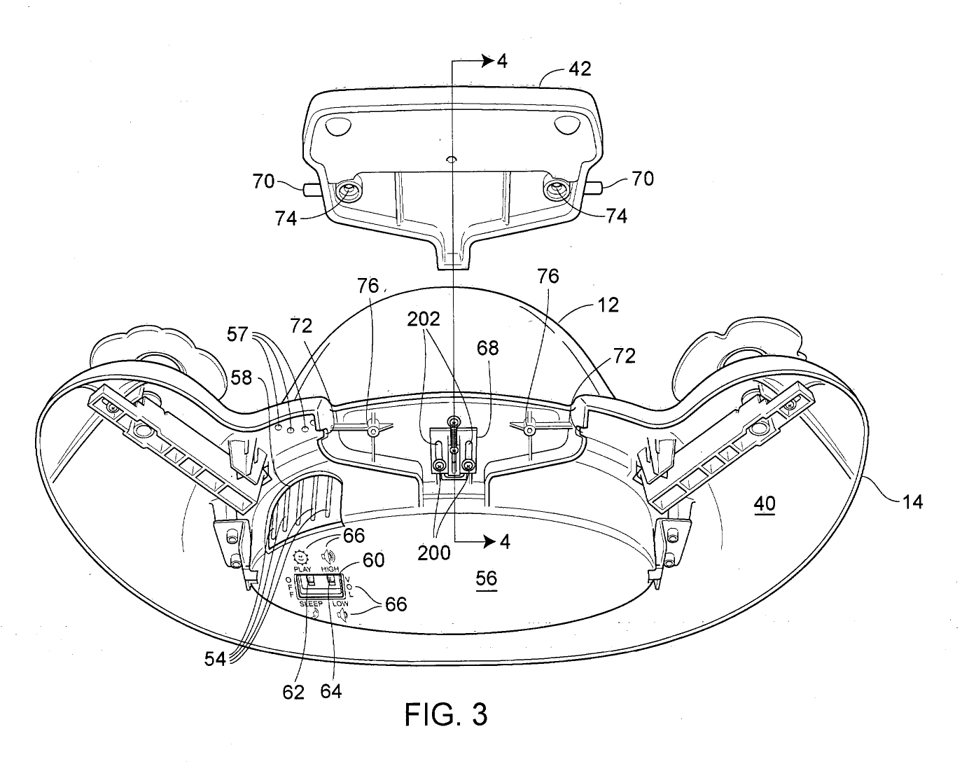

The underside of the illuminated display 10 is illustrated more fully in FIG. 3. The housing 40 and receptacle 56 of the base 14 may be configured to facilitate full usage of the lamp 12 when the lamp 12 is connected to the base 14. The receptacle 56 may include a speaker aperture 58 aligned with the speaker openings 54 of the lamp housing 48 so that sound broadcasts through the speaker openings 54, speaker aperture 58 and openings 57 may be audible from the exterior of the illuminated display 10. The receptacle 56 may further include a switch aperture 60 through which access is permitted to a three-way mode switch 62 and a volume switch 64 disposed on the bottom of the lamp housing 48. The three-way switch mode 62 may be used to cause the lamp 12 to operate in either a play mode or a sleep mode, or to be turned off when the illuminated display 10 will not be in use. The operation of the illuminated display 10 in the play mode and the sleep mode will be described more fully hereinafter.

The volume switch 64 may be used to adjust the volume of the sound broadcast by the speaker of the lamp 12 between two or more alternative volume levels. In one embodiment, the volume switch 64 may be a two-position switch alternating between a low volume and a high volume based on the position of the volume switch 64. Alternatively, the volume switch 64 may include positions for a plurality of alternative volume levels, or may be an analog switch with a sliding or rotary button to facilitate a continuous adjustment of the volume broadcast from the lamp 12 between a low volume and a high volume. Moreover, the volume switch 64 may be implemented using any other type of electromechanical switch commonly used for adjusting the volume broadcast by a speaker. In order to facilitate adjustment of the three-way mode switch 62 and volume switch 64 when the lamp housing 48 is disposed within the receptacle 56, the exterior surface of the receptacle 56 may have indicia 66 disposed thereon proximate each of the switches 62 and 64, and may be indicative of the function of each switch 62 and 64 and the position of each switch 62 and 64 to achieve the desired mode of operation or volume level, respectively, for the illuminated display 10.

As previously discussed, the receptacle 56 is configured so that the main control switch 50 and auxiliary switches 52 may be actuated by manipulation of the activation bar 42 and activation buttons 44, respectively. The activation bar 42, which is illustrated as separated from the base 14, may be configured to engage a follower plate 68 between a first position in which the follower plate 68 is disengaged from the main control switch 50, and a second position wherein the follower plate 68 engages and actuates the main control switch 50 to actuate the lamp 12. The follower plate 68 may be secured to the housing 40 by screws 200 disposed within slots 202 of the follower plate 68, whereby the screws 200 may be slidable within the slots 202 to allow the follower plate 68 to move back and forth within the housing 40.

The activation bar 42 may be pivotally attached to the housing 14 by inserting outwardly extending pivot arms 70 into corresponding notches 72 to align the activation bar 42 with the follower plate 68. The activation bar 42 may be retained on the base 14 by inserting screws (not shown) through apertures 74 of the activation bar 42 and into corresponding holes of corresponding anchor posts 76 on the underside of the housing 40. The activation bar 42 may be further configured to slide along the exterior of the corresponding anchor posts 76 to allow the activation bar 42 to pivot about the pivot arms 70 in the corresponding notches 72.

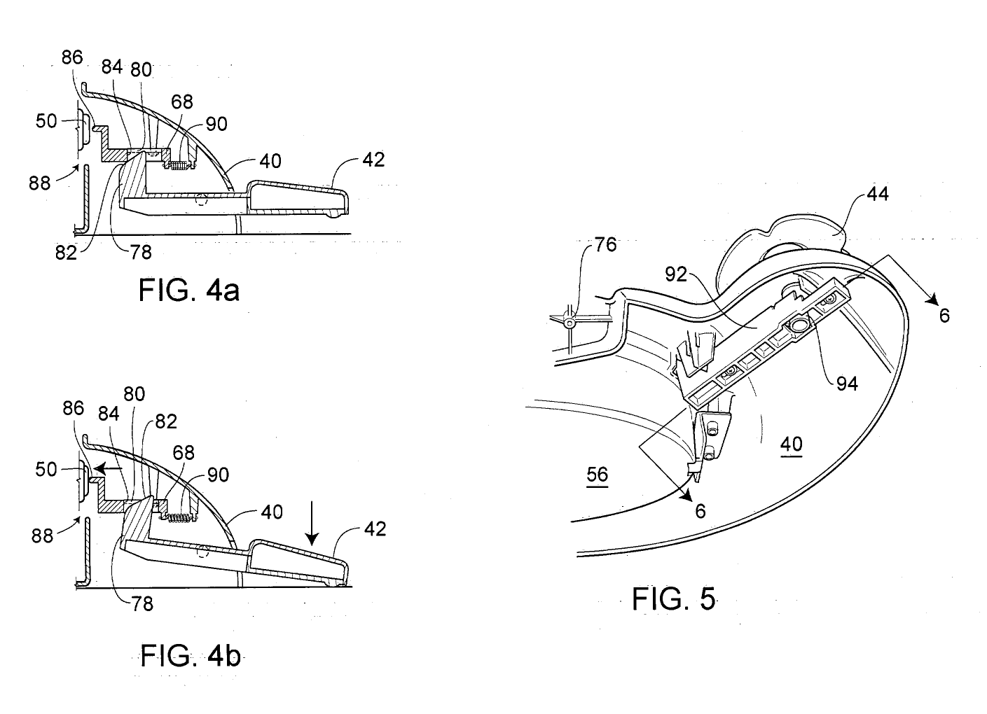

The movement of the activation bar 42 is illustrated in FIGS. 4a and 4b. Referring to FIG. 4a, the activation bar 42 includes an upwardly extending finger 78 disposed within an opening of the follower plate 68. The finger 78 includes an inclined camming surface 82 that engages a corresponding follower surface 84 of the opening 80 such that pivotal movement of the activation bar 42 translates into a linear back-and-forth movement of the follower plate 68. The follower plate 68 includes an upwardly and rearwardly extending arm 86 that may extend through an opening 88 in the housing 40 to engage the main control switch 50. A spring 90 may be attached between the follower plate 68 and housing 40 to bias the follower plate 68 and activation bar 42 to the first position wherein the arm 86 is disengaged from the main control switch 50, as shown in FIG. 4a. When the activation bar 42 is engaged and pivoted about the pivot arms 70 as shown in FIG. 4b, the camming surface 82 engages the follower surface 84 to move the follower plate 68 rearwardly with the arm 86 engaging the main control switch 50. When the activation bar 42 is disengaged, the spring 90 biases the follower plate 68 forward with the arm 86 disengaging the main control switch 50 and the activation bar 42 pivoting back to the normal disengaged position of FIG. 4a as the follower surface 84 engages the camming surface 82. While the illustrated mechanism converts rotational or pivoting motion of the activation bar 42 into linear motion of the follower plate 68 to engage the main control switch 50, it will be understood by those skilled in the art that other mechanism for activating the main control switch 50 via movement of the activation bar 42 linearly, rotationally, or through a complex motion may be used in an illuminated display in accordance with the invention.

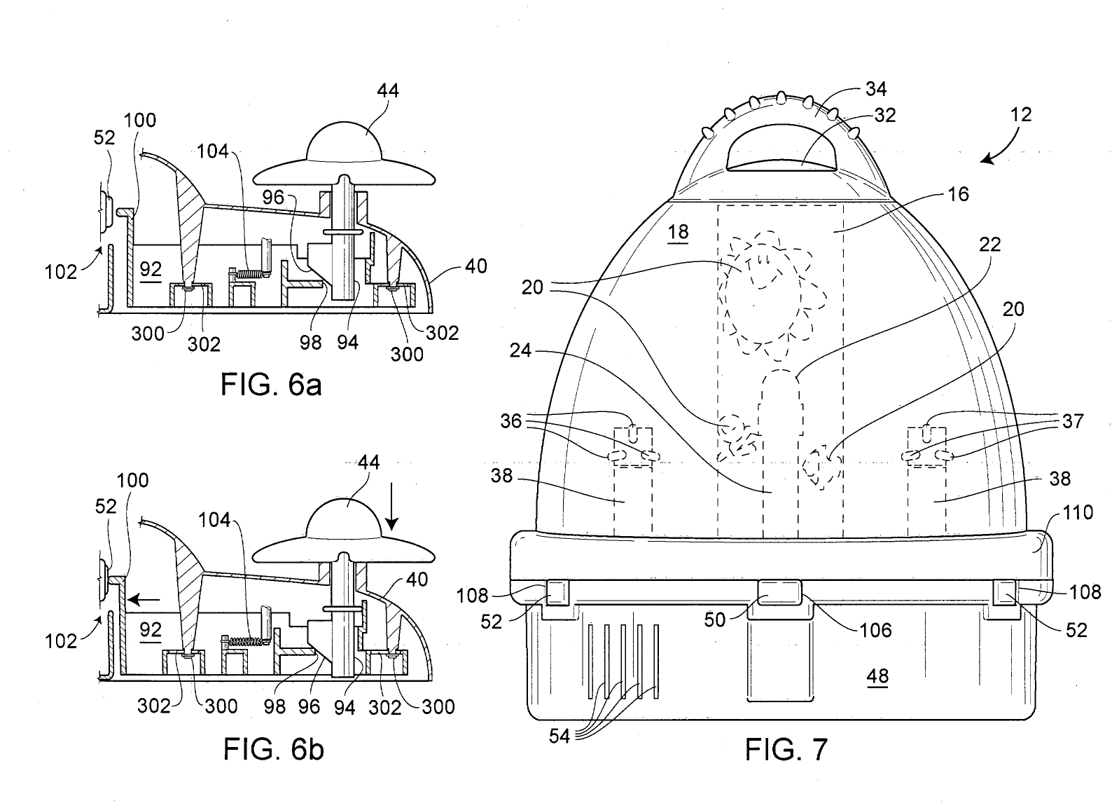

Returning to FIG. 3, the activation buttons 44 may be operatively connected to follower bars 92 to facilitate actuation of the auxiliary switches 52. As illustrated in FIG. 5, each button 44 may include a downwardly extending shaft 94 with an outwardly extending inclined camming surface 96. Movement of the activation button 44 and corresponding follower bar 92 between a first disengaged position and a second engaged position is further shown in FIGS. 6a and 6b, respectively. As illustrated in FIG. 6a, the follower bar 92 may be secured to the housing 40 by screws 300 disposed within slots 302 of the follower bar 92, whereby the screws 300 may be slidable within the slots 302 to allow the follower bar 92 to move back and forth within the housing 40. The camming surface 96 may engage a corresponding surface 98 of the follower bar 92 so that the follower bar 92 may move linearly rearwardly towards the corresponding auxiliary switch 52 when the button 44 is depressed. The follower bar 92 includes an upwardly and rearwardly extending arm 100 that may pass through an opening 102 in the housing 40 to engage the corresponding auxiliary switch 52. A spring 104 may be connected between the housing 40 and follower bar 92 to bias the follower bar 92 and activation button 44 to the disengaged position with the activation button 44 extending upwardly from the housing 40. When the activation button 44 is depressed as shown in FIG. 6b, the activation button 44 and shaft 94 move downwardly with the camming surface 96 engaging the corresponding surface 98 of the follower bar 92 to move the follower bar 92 toward the auxiliary switch 52 with the arm 100 engaging and actuating the auxiliary switch 52. When the activation button 44 is disengaged, the spring 104 biases the follower bar 92 away from the auxiliary switch 52, with the surface 98 engaging the camming surface 96 on the shaft 94 to move the activation button 44 upwardly to the normal position of FIG. 6a. While the mechanism illustrated herein translates linear movement of the activation buttons 44 into actuation of the auxiliary switches 52, it will be understood by those skilled in the art that other mechanisms for converting the movement of the activation buttons 44 linearly, rotationally, or through a complex motion into actuation of the auxiliary switches 52 may be implemented in an illuminated display in accordance with the invention.

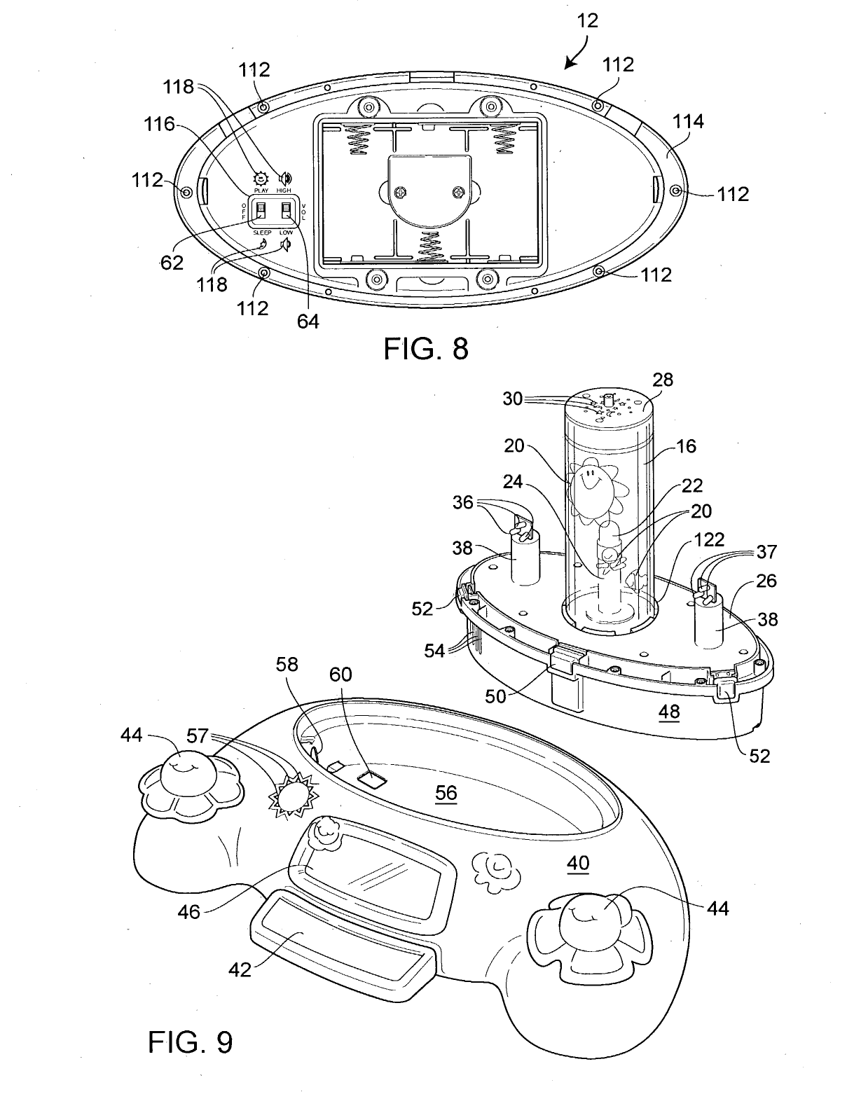

The lamp 12 is further illustrated in FIG. 7. As previously discussed, the main control switch 50 and auxiliary switches 52 are disposed in the lamp housing 48 and are accessible via openings 106 and 108, respectively. The dome 16 is attached to the lamp housing 48 by a collar 110 that may slide over the top of the dome 16 and be connected to the lamp housing 48 by a plurality of screws 112 passing through the bottom of a flange 114 of the lamp housing 48, as shown in FIG. 8. The bottom of the lamp housing 48 may further include a switch opening 116 in which the three-way mode switch 62 and volume switch 64 are disposed and accessible. As with the bottom surface of the receptacle 56 of the base 14, the lamp housing 48 may have indicia 118 disposed on the surface thereof proximate the switch opening 116 identifying the function of each of the switches 62 and 64, and the positions of the switches 62 and 64 corresponding to the particular mode or volume level corresponding to the positions of the switches 62 and 64. The lamp housing 48 may further include a compartment 120 for receiving batteries or any other alternative power supply for the lamp 12.

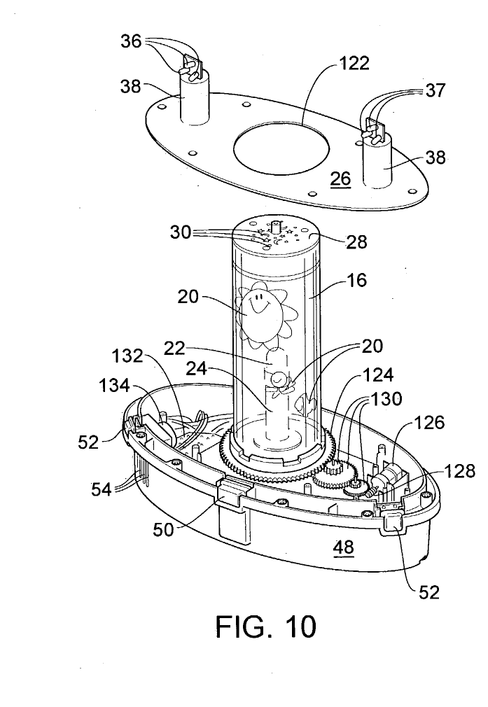

The internal components of the lamp 12 will be described more fully with reference to FIGS. 9 and 10. Referring to FIG. 9, which illustrates the lamp 12 having the dome 18 and collar 120 removed therefrom, the cylinder 16 may be disposed and rotatable within an opening 122 in the cover plate 26. As shown in FIG. 10 with the cover plate 26 removed from the lamp housing 48, the cylinder 16 may include a spur gear 124 attached to the bottom of the cylinder 16 and pivotally mounted to the interior of the lamp housing 48. The drive mechanism for the cylinder 16 may include a motor 126 having a worm gear 128 mounted on the output shaft and operatively coupled to the spur gear 124 by intermediate gears 130 so that rotation of the motor 126 is translated into rotation of the cylinder 16.

The lamp 12 may further include a controller 132, which may be a printed circuit board, disposed within the lamp housing 48. The controller 132 may be operatively connected to the light 22, LEDs 36 and 37, main control switch 50, auxiliary switches 52, motor 126, and a speaker 134 via electrical wires (not shown) to control the operation of the lamp 12. The controller 132 may further be operatively connected to the three-way mode switch 62, volume switch 64 and a power source accessible through the bottom surface of the lamp housing 48.

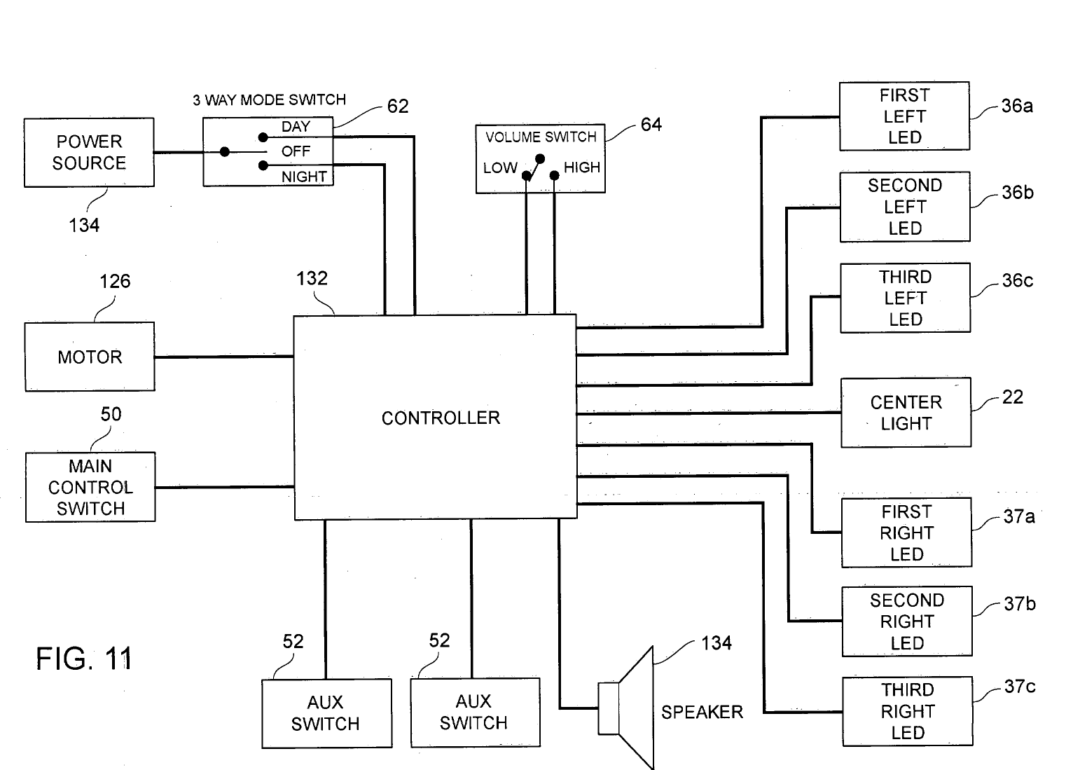

FIG. 11 is a block diagram of a number of components that may be incorporated into the illuminated display 10 and which were previously described herein. The illuminated display 10 may include the controller 132 implemented on a circuit board and containing the control logic and sound generation data implemented via circuitry contained on a conventional printed circuit board, with the control logic and sound generation data being stored directly on the printed circuit board. It should also be appreciated that although the controller 132 may be implemented on a printed circuit board, more complex implementations of the illuminated display 10 may be implemented wherein the controller 132 may comprise, among other components, a program memory, a microcontroller or microprocessor (MP), a random-access memory (RAM), read-only member (ROM), and an input/output (I/O) circuit, all of which may be interconnected. It should further be appreciated that the controller 132 may include multiple microprocessors. Similarly, the memory of the controller 132 may include multiple RAMs and multiple program memories depending on the complexity and requirements of a specific implementation. It should also be appreciated that the I/O circuit may include a number of different types of I/O circuits, such as light-generation circuits, sound-generation circuits, and the like. The RAMs, ROMs and program memories may be implemented as semi-conductor memories, magnetically readable memories, and/or optically readable memories, for example.

As previously discussed, the illuminated display 10 may be configured with a plurality of modes of operation. In one example of a mode of operation, the illuminated display 10 may be configured for play by an infant wherein the illuminated display 10 responds when the infant actuates the main control switch 50 or auxiliary light switches 54 either by direct engagement of the switches 50 and 52, or via the activation bar 42 and activation buttons 44. In order to initiate the play mode of the illuminated display 10, the three-way mode switch 62 may be moved to the play or daytime position as indicated by the indicia 66 and/or 118. When the three-way mode switch 62 is switched to the play mode position, the three-way mode switch 62 connects the controller 132 to a power source 134 for the illuminated display 10. The volume switch 64 may also be switched to the desired volume level. Once the three-way mode switch 62 is set to the play mode position, the controller 132 may respond to actuation of the main control switch 50 by illuminating the light 22 and activating the motor 126 to drive the cylinder 16. As the cylinder 16 rotates, the images defined by the indicia 20 on the cylinder 16 are projected onto the dome 18, with the projected images changing size and distortion as the distance between the cylinder 16 and the inner surface of the dome 18 changes due to the geometry of the dome 18. At the same time, the controller 132 may transmit output signals to the speaker 134 causing the speaker 134 to broadcast one of a plurality of introductory sounds, such as birds chirping, an infant laughing, and the like, followed by one of a plurality of songs stored at the controller 132, such as Three Blind Mice, Hickory Dickory Dock, London Bridge, Ring Around the Rosie, and the like.

The controller 132 may continue to cause the speaker 134 to broadcast the song until the end of the song, at which time the controller 132 may deactivate the light 22, motor 126 and speaker 134. If the controller 132 detects a subsequent actuation of the main control switch 50 while the controller 132 causes the speaker 134 to broadcast one of the plurality of songs, the controller 132 may be programmed to transmit output signals to the speaker 134 causing the speaker 134 to broadcast the same or a different one of the plurality of transition sounds, followed by another of the plurality of available songs. The controller 132 may be programmed to cause the speaker 134 to broadcast the available transition sounds and songs in a predetermined sequence or, alternatively, to randomly select the transition sound and song to be played after detecting the actuation of the main control switch 50. As long as the main control switch 50 is actuated prior to the completion of a given one of the plurality of songs, the controller 132 may continue to activate the light 22 and motor 126, and to transmit output signals to the speaker 134 for a continuous illuminated display with sound accompaniment. At any time, the controller 132, light 22, motor 126 and speaker 134 may be deactivated by resetting the three-way mode switch 62 from the play mode position to an off position or to a different mode position.

As another example, the illuminated display 10 may be configured with a nighttime or sleep mode wherein the lamp 12 may function as a combination nightlight and music box. In order to initiate the nighttime mode, the three-way mode switch 62 may be set to a predetermined position to cause the controller 132 to operate in the desired sleep mode. When the controller 132 detects actuation of the main control switch 50 while set to the nighttime mode, the controller 132 may activate the light 22 and motor 126 to cause the images on the cylinder 16 to be projected onto the dome 18 as the cylinder 16 is rotated by the motor 126. The controller 132 may transmit output signals to the speaker 134 causing the speaker 134 to play one of a plurality of songs stored at the controller 132 as an accompaniment to the illuminated image display. If the controller 132 does not detect a subsequent actuation of the main control switch 50, the controller 132 may continue to activate the light 22 and motor 126, and to transmit output signals to the speaker 134, until the end of the currently playing song. Alternatively, the controller 132 may continue to transmit output signals to the speaker 134 for subsequent songs, the order of which may be predetermined or randomly determined at the controller 132, for a predetermined period of time after which the controller 132 deactivates the light 22 and motor 126, and ceases transmitting output signals to the speaker 134. If the controller 132 detects the actuation of the main control switch 50 while the light 22 and motor 126 are activated and the controller 132 is transmitting output signals to the speaker 134, the controller 132 may deactivate the light 22 and motor 126, and cease transmitting output signals to the speaker 134. As with the previously described play mode, the controller 132, light 22, motor 126 and speaker 134 may also be deactivated at any time by resetting the three-way mode switch 62 to either the off position or to an alternate mode position.

When the three-way mode switch 62 is positioned to allow the illuminated display 10 to function in one of the predetermined operational modes, the controller 132 may be programmed to activate lights 36a-36c and 37a-37c upon detecting the actuation of one of the auxiliary switches 54. When one of the auxiliary switches 54 is actuated, either by directly depressing the auxiliary switch 54 or depressing the corresponding actuation button 44 when the lamp 12 is disposed in the base 14, the controller 132 may cause the lights 36a-36c and 37a-37c to illuminate in unison, or in a predetermined or randomly determined sequence for a period of time. Simultaneously, the controller 132 may transmit output signals to the speaker 134 for broadcasting one of a plurality of available sounds, such as an infant laughing, a bell ringing, a spring springing, birds chirping, and the like. The sequence of illumination of the lights 36a-36c and 37a-37c may correspond to one of the plurality of sounds that may be transmitted by the controller 132 to the speaker 134, such that each time one of the sounds is transmitted to the speaker 134, the same one of the sequences of illumination of the lights 36a-36c and 37a-37c is caused by the controller 132. Each time one of the auxiliary switches 54 is actuated, the controller 132 may alternate the one of the sounds and sequence of illumination of the lights 36a-36c and 37a-37c based on either a predetermined or a randomly determined order.

While the preceding text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

What is claimed is:

1. An illuminated display for use by an infant comprising:
a cylinder fabricated from a translucent material and having at least one image disposed on a surface of the cylinder;
a motor operatively coupled to the cylinder and being adapted to rotate the cylinder when the motor is activated;
an illumination source disposed within the cylinder and being adapted to project light outwardly through the surface of the cylinder; and
a dome having the cylinder and the illumination source being disposed therein and being adapted so that the light projecting from the illumination source through the surface of the cylinder projects at least one projected image on the dome corresponding to the at least one image disposed on the surface of the cylinder, the at least one projected image being visible from the exterior of the dome,
wherein the cylinder, the illumination source and the dome are adapted such that the at least one projected image has a first size when the cylinder rotates through a first position and the at least one projected image has a second size when the cylinder rotates through a second position.

2. An illuminated display as defined in claim 1, wherein the dome has a cross-section being adapted such that a first portion of the dome corresponding to the first position of the cylinder, and upon which the at least one projected image is projected when the cylinder is in the first position, having a first distance between the at least one projected image and the corresponding at least one image on the surface of the cylinder, and a second portion of the dome corresponding to the second position of the cylinder, and upon which the at least one projected image is projected when the cylinder is in the second position, having a second distance between the at least one projected image and the corresponding at least one image on the surface of the cylinder, and wherein the first distance is not equal to the second distance.

3. An illuminated display as defined in claim 1, wherein the at least one projected image has a first shape when the cylinder rotates through the first position and a second shape when the cylinder rotates through the second position.

4. An illuminated display as defined in claim 1, further comprising:
a first switch; and
a controller operatively coupled to the illumination source, the motor and the first switch, the controller being programmed to detect a first actuation of the first switch and to activate the illumination source and the motor in response to detecting the first actuation of the first switch.

5. An illuminated display as defined in claim 4, further comprising a speaker operatively coupled to the controller and being adapted to output sounds, the controller being programmed to cause the speaker to output a first musical sound in response to detecting the first actuation of the first switch.

6. An illuminated display as defined in claim 5, wherein the controller is programmed with a first mode of operation wherein the controller is programmed to detect a second actuation of the first switch, and the controller is programmed to cause the speaker to output a second musical sound in response to detecting the second actuation of the first switch while the controller is causing the speaker to output the first musical sound.

7. An illuminated display as defined in claim 5, wherein the controller is programmed with a second mode of operation wherein the controller is programmed to detect a second actuation of the first switch, and the controller is programmed to discontinue causing the speaker to output the first musical sound in response to detecting the second actuation of the first switch while the controller is causing the speaker to output the first musical sound.

8. An illuminated display as defined in claim 4, further comprising:
a second illumination source operatively coupled to the controller; and
a second switch operatively coupled to the controller,
the controller being programmed to detect the actuation of the second switch and to activate the second illumination source in response to detecting the actuation of the second switch.

9. An illuminated display as defined in claim 1, wherein the cylinder has a circular cross-section and the dome has an oblong cross-section.

10. An illuminated display as defined in claim 1, wherein the dome is fabricated from a translucent material and comprises an inner surface having a semi-translucent material disposed thereon.

11. An illuminated display as defined in claim 1, wherein the dome is fabricated from a semi-translucent material.

12. An illuminated display for use by an infant, comprising:
a lamp comprising:
a dome fabricated from a translucent material, and having an oblong cross-section and a coated surface,
a rotatable cylinder fabricated from a translucent material and disposed within the dome, the cylinder having a circular cross-section and at least one image disposed on a surface of the cylinder,
a first illumination source disposed within the cylinder and being adapted to project light outwardly through the surface of the cylinder such that the light projecting from the first illumination source through the surface of the cylinder projects at least one projected image on the coated surface of the dome corresponding to the at least one image disposed on the surface of the cylinder, wherein the at least one projected image has a first size when the cylinder rotates through a first position and the at least one projected image has a second size when the cylinder rotates through a second position,
a second illumination source disposed within the dome,
a motor operatively coupled to the cylinder and being adapted to rotate the cylinder when the motor is actuated,
a first switch,
a second switch,
a speaker being adapted to output sounds, and
a controller coupled to the first illumination source, the second illumination source, the motor, the first switch, the second switch and the speaker,
the controller being programmed to detect a first actuation of the first switch,
the controller being programmed to activate the first illumination source and the motor in response to detecting the first actuation of the first switch, and to cause the speaker to output a first musical sound,
the controller being programmed to operate in a first mode wherein the controller is programmed to detect a second actuation of the first switch and cause the speaker to output a second musical sound in response to detecting the second actuation of the first switch, and to cease causing the speaker to output sound at the conclusion of the first musical sound,
the controller being programmed to operate in a second mode and to detect a second actuation of the first switch, wherein the controller is programmed to cause the speaker to output a plurality of musical sounds for a predetermined period of time during which the controller does not detect the second actuation of the first switch, and to cease causing the speaker to output the plurality of musical sounds in response to detecting the second actuation of the first switch, and
the controller being programmed to detect an actuation of the second switch and to activate the second illumination source in response to detecting the actuation of the second switch; and
a base comprising:
a housing,
a first activation member mounted on the housing,
a second activation member mounted on the housing, and
a receptacle in the housing being adapted to demountably receive the lamp, wherein the first switch is aligned with the first activation member when the lamp is disposed within the receptacle such that movement of the first activation member from a first switch disengaged position to a first switch engaged position causes actuation of the first switch, and wherein the second switch is aligned with the second activation member when the lamp is disposed within the receptacle such that movement of the second activation member from a second switch disengaged position to a second switch engaged position causes actuation of the second switch.

13. An illuminated display as defined in claim 12, wherein the first activation member moves through a circular path between the first switch disengaged position and the first switch engaged position.

14. An illuminated display as defined in claim 12, further comprising a first engagement member operatively coupled to the first activation member and being adapted to move through at linear path to actuate the first switch when the first activation member moves from the first switch disengaged position to the first switch engaged position.

15. An illuminated display as defined in claim 12, wherein the second activation member moves through a linear path between the second switch disengaged position and the second switch engaged position.

16. An illuminated display as defined in claim 12, further comprising a second engagement member operatively coupled to the second activation member and being adapted to move through at linear path to actuate the second switch when the second activation member moves from the second switch disengaged position to the second switch engaged position.

17. An illuminated display as defined in claim 12, wherein the controller is programmed to cause the speaker to output a first transition sound before causing the speaker to output the first musical sound in response to detecting the first actuation of the first switch.

18. An illuminated display as defined in claim 17, wherein the controller is programmed to cause the speaker to output a second transition sound in response to detecting the second actuation of the first switch.

19. An illuminated display as defined in claim 12, wherein the controller is programmed to cause the speaker to output a second illumination source transition sound in response to detecting the actuation of the second switch.

20. An illuminated display for use by an infant, comprising:
a dome having a first cross-section,
a rotatable cylinder fabricated from a translucent material and disposed within the dome, the cylinder having a second cross-section and at least one image disposed on a surface of the cylinder,
a first illumination source disposed within the cylinder and being adapted to project light outwardly through the surface of the cylinder such that the light projecting from the first illumination source through the surface of the cylinder projects at least one projected image on the dome corresponding to the at least one image disposed on the surface of the cylinder, the at least one projected image being visible from the exterior of the dome, wherein the first and second cross-sections are configured such that the at least one projected image has a first size when the cylinder rotates through a first position and the at least one projected image has a second size when the cylinder rotates through a second position,
a motor operatively coupled to the cylinder and being adapted to rotate the cylinder when the motor is actuated,
a first switch,
a speaker being adapted to output sounds, and
a controller coupled to the first illumination source, the motor, the first switch, and the speaker,
the controller being programmed to detect a first actuation of the first switch,
the controller being programmed to activate the first illumination source and the motor in response to detecting the first actuation of the first switch, and to cause the speaker to output a first musical sound, and the controller being programmed to operate in a first mode wherein the controller is programmed to detect a second actuation of the first switch and cause the speaker to output a second musical sound in response to detecting the second actuation of the first switch, and to cease causing the speaker to output sound at the conclusion of the first musical sound.

21. An illuminated display as defined in claim 20, wherein the controller is programmed to operate in a second mode and to detect a second actuation of the first switch, the controller being programmed to cause the speaker to output a plurality of musical sounds for a predetermined period of time during which the controller does not detect the second actuation of the first switch, and to cease causing the speaker to output the plurality of musical sounds in response to detecting the second actuation of the first switch.

22. An illuminated display as defined in claim 20, the lamp comprising a second illumination source disposed within the dome and operatively connected to the controller, a second switch operatively connected to the controller, the controller being programmed to detect an actuation of the second switch and to activate the second illumination source in response to detecting an actuation of the second switch.

23. An illuminated display as defined in claim 22, wherein the controller is programmed to cause the speaker to output a second illumination source transition sound in response to detecting the actuation of the second switch.

24. An illuminated display as defined in claim 20, wherein the controller is programmed to cause the speaker to output a first transition sound before causing the speaker to output the first musical sound in response to detecting the first actuation of the first switch.

25. An illuminated display as defined in claim 24, wherein the controller is programmed to cause the speaker to output a second transition sound in response to detecting the second actuation of the first switch.

26. An illuminated display as defined in claim 20, wherein the first cross-section is an oblong cross-section, and the second cross-section is a circular cross-section.

27. An illuminated display as defined in claim 20, wherein the dome is fabricated from a translucent material and comprises an inner surface having a semi-translucent material disposed thereon.

28. An illuminated display as defined in claim 20, wherein the dome is fabricated from a semi-translucent material.
